(19) United States
(12) Patent Application Publication
(10) Pub. No.: US 2005/0038674 A1
(43) Pub. Date: Feb. 17, 2005

(54) System and method for managing a chronic medical condition

(76) Inventors: James R. Braig, Piedmont, CA (US); Peter Rule, Los Altos Hills, CA (US); Michael A. Munrow, Belmont, CA (US); Philip C. Hartstein, Palo Alto, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/826,004

(22) Filed: Apr. 15, 2004

Related U.S. Application Data
(60) Provisional application No. 60/463,517, filed on Apr. 15, 2003.
(60) Provisional application No. 60/508,425, filed on Oct. 3, 2003.

(51) Int. Cl. G06F 17/60

(52) U.S. Cl. 705/2; 600/365; 128/920; 435/14

(57) ABSTRACT

A system for management of a chronic medical condition generally comprises a plurality of networked physical and/or virtual elements configured to cooperate to aid in management of a chronic medical condition of a patient. The system is configured to provide a primary caregiver with current data relating to the patient's medical condition, and to allow the caregiver to provide appropriate changes to the patient's treatment via an analyte detection meter. The meter is generally configured to calculate a treatment dosage by combining a plurality of patient-affected and caregiver-affected variables. One embodiment relates to a system for management of a diabetic condition in which the primary caregiver is provided with glucose concentration data as well as other information relating to a diabetic condition. The primary caregiver can then make appropriate changes to correction factors to be implemented in an analyte detection meter which is configured to calculate an insulin dosage.

### CROSS REFERENCE TO RELATED APPLICATIONS

This Application claims the benefit of an earlier filing date under 35 U.S.C. § 119(e) based on U.S. Provisional Patent Application Nos. 60/463,517, filed on Apr. 15, 2003 and 60/508,425, filed on Oct. 3, 2003.

### BACKGROUND

1. Field of the Invention

The invention relates in general to the field of disease management, and specifically to a multi-component system for aiding in management of a chronic medical condition.

2. Description of the Related Art

Diabetes Mellitus is a chronic condition which affects millions of people in this country and around the world. About ten percent of these people have what is termed “type 1 diabetes” or “insulin-dependent diabetes,” and require regular injections of insulin in order to maintain blood sugar levels within an acceptable range. Many of the remaining (type 2) diabetics have “insulin resistance,” which is generally a failure of the body's cells to properly use insulin.

Intensive management of analyte levels related to a diabetic condition has been shown to have substantial benefit to diabetics. One study, known to the skilled artisan as the Diabetes Control and Complications Trial (DCCT), showed that intensive insulin therapy had substantial benefits, and suggested a target blood glucose level of 150 mg/dL. In order to maintain a blood glucose level within an acceptable range of a target value, insulin-dependent diabetic patients must regularly monitor their blood glucose concentrations, and take appropriately-dosed quantities of insulin.

Many home-use and portable glucose measuring devices have been made available for simplifying the task of measuring a patient's blood glucose level. These devices typically report the patient's blood glucose level to the patient. A patient's physician will typically provide the patient with “correction factors,” i.e. constants which can be multiplied with a measured glucose concentration to determine a dose of insulin required to bring the patient's blood glucose level to within an acceptable range of a target level.

Such insulin dosage calculations are typically performed by patients, or a relative of a patient using correction factor values which are typically given to the patient by a caregiver during a clinical visit. Thus, in most cases, a patient's correction factors are updated by a physician only as often as the patient visits the doctor. This can be as infrequently as once every few months, and can thus lead to inaccuracy of a patient's dosage calculation. Additionally, errors made by a patient in individual calculations can cause further inaccuracy in the patient's dosage, and thereby more variation in the patient's blood glucose level.

Notwithstanding the success of the existing systems and methods for managing diabetes, there remains a need for further improvements to systems for management of a diabetic condition, specifically including more consistently accurate dosage calculations, and more frequently updatable management parameters.

### SUMMARY

Thus, the present invention seeks to provide a system for managing a chronic medical condition such as diabetes. The system and methods described herein generally involve the connection of a plurality of elements which can be configured to work together in an effort to better manage a patient's condition.

According to one embodiment of the invention, a method of remotely managing a diabetic condition comprises configuring a meter to calculate a correction bolus using a correction algorithm. The method further comprises configuring the meter to measure a concentration of an analyte in a material sample from a patient. In some embodiments, the analyte to be measured is an indicator of a diabetic condition. A result of the measurement is a variable used in the correction algorithm. Some embodiments of the method further includes providing a central server in two-way communication with the meter and configuring the server to store information received from said meter. The method can also include allowing a medical caregiver to access the central server using a terminal in two-way communication with the central server; and further allowing the medical caregiver to modify the correction algorithm in the meter via the terminal.

According to another embodiment of the invention, a system for allowing a medical caregiver to remotely manage a diabetic condition of a patient is provided. The system comprises a central server containing a database of information associated with at least a first patient and a meter associated with the first patient. The meter is adapted to calculate a correction bolus using a correction algorithm and a plurality of patient-affected and caregiver-affected variables. The meter is also in two-way communication with the central server. A terminal is associated with the caregiver and is adapted to allow the caregiver to view the database associated with at least the first patient. The terminal is further adapted to allow the caregiver to modify the correction algorithm in the meter associated with the first patient.

In yet another embodiment of the invention, a system for managing a diabetic condition of a patient comprises a handheld meter having a digital memory and computing abilities. The digital memory is programmed with a correction algorithm for calculating a correction bolus from a plurality of parameters. A central server is in two-way communication with the meter. At least some of the parameters for calculating the correction bolus are stored in and updatable by said central server. The central server is configured to allow a care giver to remotely modify at least one of said parameters for calculating a correction bolus. In some embodiments, the functions of the server can be implemented in the meter itself, thereby eliminating the need for a central server as a separate element in the network. In embodiments of a de-centralized patient management system, a plurality of system elements can communicate with one another according to various peer-to-peer or other de-centralized protocols.

Another embodiment of the invention provides a method for communicating patient information to a caregiver for use in managing a diabetic condition of a patient. The method includes providing a meter configured to measure a concentration of an analyte and to at least temporarily store the results of the measurement. The meter is associated with said patient and configured to communicate to the caregiver by presenting to the caregiver a choice of at least one diabetes-relevant datum for communication by the meter to the caregiver.

According to an alternative embodiment, the caregiver is presented with a choice of at least one diabetic-specific datum for communication from said patient-specific meter to said caregiver, and the choice is implemented via the server.

According to still another embodiment, a method of managing a diabetic condition by placing a medical caregiver in electronic communication with a diabetic patient via a communications network is provided. The method comprises providing a server having storage and processing capabilities, and at least one patient-specific meter configured to measure a concentration in a diabetic patient of at least one analyte associated with diabetes. The meter is further configured to calculate a correction bolus based on the concentration of the measured analyte. The method further includes providing a communication terminal for the caregiver, and communicating at least one datum relating to the diabetic condition from the meter to the caregiver. The method also includes communicating at least one datum relating to the correction bolus from the caregiver to the meter.

### BRIEF DESCRIPTION OF DRAWINGS

Having thus summarized the general nature of the invention, certain preferred embodiments and modifications thereof will become apparent to those skilled in the art from the detailed description herein having reference to the figures that follow, of which:

FIG. 1 is a schematic illustration of data flows between a plurality of interconnected elements of the present management system;

FIG. 1A is a schematic view of data flows in an alternative embodiment of a patient management system;

FIG. 2 is a flow chart illustrating an adaptive reminder routine;

FIG. 3 is a flow chart representing one embodiment of a cycle of a correction algorithm including a step of a caregiver updating the algorithm based on information output by the meter;

FIG. 4 is a flow chart representing one embodiment of a measurement cycle to be carried out by an analyte detection meter as described herein;

FIG. 5 is an illustration of an insulin pen for use with one embodiment of an analyte detection meter; and

FIG. 6 is a schematic illustration of an analyte detection meter with a mechanical interface for receiving an insulin pen.

### DETAILED DESCRIPTION

With reference to the attached figures, embodiments of a patient management system and methods of implementing and/or using such a system will now be described. In certain embodiments, the patient management system supports input and modification of patient-affected and caregiver-affected variables stored in a patient-specific analyte detection meter or in other components of the system, which variables are used to calculate a treatment dosage for management of a medical condition. Other embodiments include various devices and methods which can be used as part of, or in cooperation with, the patient management system to aid in management of the patient's medical condition. Certain methods related to the management system involve providing a caregiver access to up-to-date analyte-concentration measurement data from a patient, and allowing the caregiver to modify algorithms and/or parameters within the meter to affect the patient's treatment.

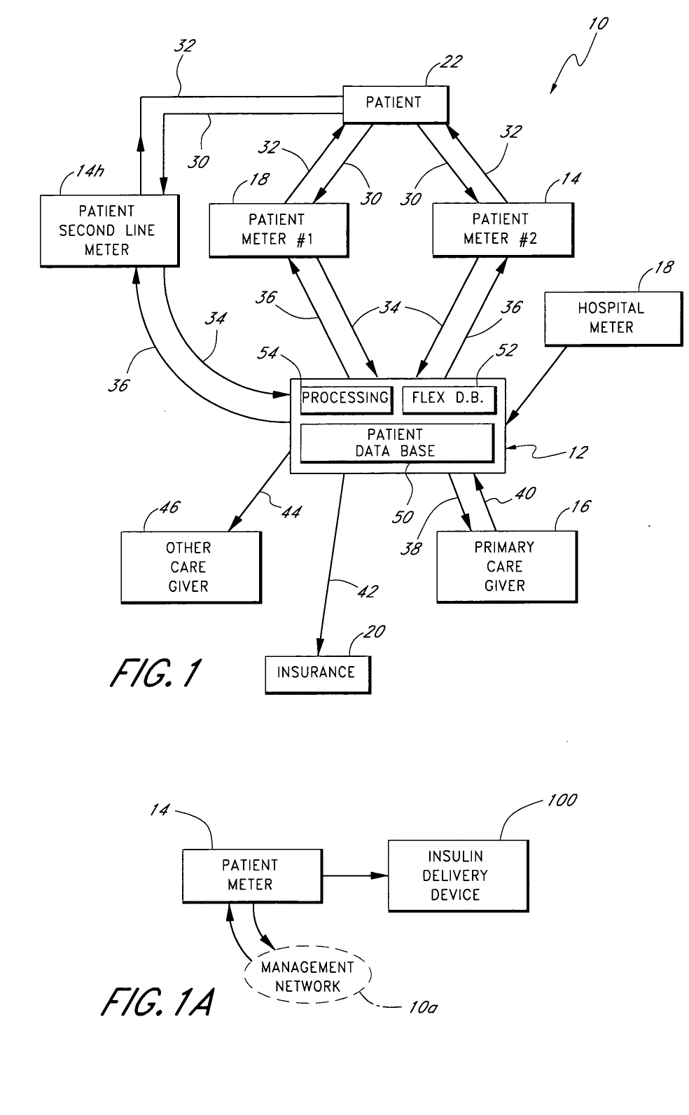

With reference to FIG. 1, a patient management system 10 having desired features and advantages may generally include a network of interconnected physical and/or virtual elements or modules configured to process information and function in cooperation to aid in management of a chronic medical condition of a patient.

In certain embodiments, the patient management system 10 generally includes a number of elements as depicted in FIG. 1, such as a central server 12, at least one patient-specific analyte detection meter 14, and at least one terminal 16 associated with a caregiver. Some embodiments may further comprise a hospital-based analyte detection meter 18, an insurance-provider terminal 20, and/or a secondary-caregiver terminal 46. Of course, the system 10 may include additional elements as desired. Alternatively, certain elements or various sub-combinations of these elements can be used independently of the other elements of a patient management system.

Although the patient management system 10 is presently described in relation to managing a single patient possessing one or more patient-specific meters 14, it should be understood that the system 10 can be used for managing many patients, each possessing one or more patient-specific meters 14. More generally, any other element of the system 10 can be provided in any number as desired. As used herein, “patient-specific meter” is a broad term, and is used in its ordinary sense to refer to a meter which can be uniquely identified with a single patient. Other meters described herein, such as the hospital meter 18, may be used by multiple patients.

As used herein, “caregiver” is a broad term and is used in its ordinary sense to refer, without limitation, to any person authorized to participate in the treatment of a patient. Examples of caregivers include physicians, physician assistants, nurses, parents, guardians, family members, etc.

The server 12, in the depicted embodiment, generally comprises and/or houses at least one patient database 50, a flexible database 52, and a processing center 54. (The databases 50, 52 are discussed in greater detail below.) The server 12 is preferably configured to be in one-way or two-way electronic communication, as further described herein, with the other elements of the system 10, such as the patient-specific analyte detection meter(s) 14, the caregiver terminal 16, any hospital-based meter 18, any insurance-provider terminal 20, and/or any secondary-caregiver terminal 46.

FIG. 1 also depicts a plurality of possible paths or links by which data can flow between the various elements of the patient management system 10. A patient 22 may possess one or a plurality of personal “patient-specific” meters 14, and may also have a home-based meter 14h. The patient 22 generally interfaces with the server 12 via the meters 14; however, in certain embodiments the patient 22 may be provided access to the server 12 and/or the database(s) 52, 54 (or other elements of the system 10) directly via any suitable computing device such as a PC, PDA, etc. connected to the system 10.

Data 30 flowing from the patient 22 to at least one of the patient-specific meters 14, can generally include any one or combination of the following: (a) login information such as a username and password; (b) current time/date/day; (c) exercise data such as the type and/or duration of exercise engaged in or to be engaged in, and/or the time and date that the exercise was or will be engaged in; (d) the patient's current height, weight, and/or age; (e) diet information such as the type and/or quantity of food and/or drink consumed or to be consumed, and/or the time and date that the food and/or drink was consumed or will be consumed; (f) insulin consumption information such as the type and/or quantity of insulin consumed or to be consumed, and/or the time and date that the insulin was consumed or will be consumed; (g) material samples for analysis; and/or generally any other factors affecting glucose concentration.

Data 34 flowing from the meter(s) 14 to the server 12 can generally include any one or combination of the following: (a) analyte-concentration measurement values (including, if desired, corresponding dates/times and meter identification information); (b) update status pertaining to the algorithm(s) employed by the meter(s) 14 to calculate and/or measure analyte concentration, or to any other software/firmware employed in the meter(s) 14; (c) meter calibration status; (d) physical location of the meter(s) (e.g., as may be determined by a GPS system (not shown) built into the meter(s) 14); (e) patient exercise data as discussed above; (f) the patient's current height, weight, and/or age; (g) patient diet information as discussed above; (h) patient insulin consumption information as discussed above; (i) rate of use, and/or quantities used, of disposable sample elements (e.g. test strips).

Data 38 flowing from the server 12 to the primary caregiver terminal 16 can generally include any one or combination of the following: (a) analyte-concentration measurement values (including, if desired, corresponding dates/times and meter identification information); (b) update status pertaining to the algorithm(s) or software/firmware employed in the meter(s) 14 as discussed above; (c) meter calibration status; (d) physical location of the meter(s); (e) patient exercise data as discussed above; (f) the patient's current height, weight, and/or age; (g) patient diet information as discussed above; (h) patient insulin consumption information as discussed above; (i) patient insurance information; (j) patient disease level classification; (k) current standing orders pertaining to the patient's care and made by a caregiver; (1) rate of use, and/or quantities used, of disposable sample elements. The data 38 may also comprise second-order information generated by the database(s) 50, 52, such as trends in analyte-concentration measurement values; the patient's exercise, diet, and/or insulin-consumption history; and/or effects of exercise, diet and/or insulin consumption on patient analyte concentration. In various embodiments, the data 38 may generally include any information contained in the patient database 50. The system 10 may permit the primary caregiver 16 to request specific data (such as any of the data 38) at specific times, or alternatively a previously specified set or type of data selected from the data 38 can be “pushed” to the primary caregiver at regular time intervals as desired.

Data 40 flowing from the primary caregiver terminal 16 to the server 12 can generally include any one or combination of the following: (a) updates or other modifications to the algorithm(s) employed by the meter(s) 14 to calculate and/or measure analyte concentration, or to any other software/firmware employed in the meter(s) 14; (b) commands to lock a patient out of an un-calibrated meter; (c) requests to measure a secondary analyte such as a ketone, HBA1C, etc.; (d) requests to take an additional measurement of a given analyte; (e) requests to visit the caregiver; (f) changes to patient disease level classification; (g) requests to start, adjust or terminate any one or combination of the patient's: diet, insulin consumption, exercise regimen, and/or analyte-concentration measurement schedule; (h) text messages (e.g., general medical advice, requests for additional information from the patient, or other treatment-related information) from the caregiver to the patient. In one embodiment, the caregiver can send any or all such information, requests, updates, etc. directly to the patient's meter(s) 14 and the meter(s) can relay such information to the server 12 for storage in the patient's database 50 for any record-keeping or trend-tracking purposes as desired.

Data 36 flowing from the server 12 to the meter(s) 14 can generally include any one or combination of the following: (a) updates or other modifications to the algorithm(s) or other software/firmware employed in the meter(s) 14 as discussed above; (b) commands to lock a patient out of an un-calibrated meter; (c) requests to measure a secondary analyte such as a ketone, HBA1C, etc.; (d) requests to take an additional measurement of a given analyte; (e) requests to visit the caregiver; (f) changes to patient disease level classification; (g) requests to start, adjust or terminate any one or combination of the patient's: diet, insulin consumption, exercise regimen, and/or analyte-concentration measurement schedule; (h) reminders to calibrate the meter(s) 14; (i) calibration information; (j) text messages (e.g., general medical advice, requests for additional information from the patient, or other treatment-related information) from the caregiver to the patient.

Data 32 flowing from the patient-specific meter(s) 14 to the patient 22 can generally include any one or combination of the following: (a) analyte-concentration measurement values; (b) requests to measure a secondary analyte such as a ketone, HBA1C, etc.; (c) requests to take an additional measurement of a given analyte; (d) requests to visit the caregiver; (e) requests to start, adjust or terminate any one or combination of the patient's: diet, insulin consumption, exercise regimen, and/or analyte-concentration measurement schedule; (f) reminders to calibrate the meter(s) 14; (g) calibration information.

Data 42 flowing from the server 12 to any insurance-provider terminal(s) 20 may include any one or combination of the following: rate of use, and/or quantities used, of disposable sample elements; analyte-concentration trend information as may indicate patient compliance with a management plan; and/or information relating to the patient's general health.

Data 44 flowing from the server 12 to any secondary caregiver terminal(s) 46 can include any one or combination of the following: analyte-concentration measurement values, trends in analyte-concentration measurement values, and/or any other information which may be useful to a secondary caregiver peripherally involved in the patient's care. In one embodiment, the data 44 flowing from the server 12 to the secondary caregiver terminal(s) 46 is similar to the data 38 flowing from the server 12 to the primary caregiver terminal 16. Alternatively the secondary caregiver may be granted only limited access to a patient's database. This may be appropriate where a secondary caregiver such as a mentor may be interested in tracking a patient's progress towards management of the medical condition.

As discussed above, an individual patient database 50 may be provided, in certain embodiments, for each unique patient under management by the system 10. Thus, a plurality of patient databases 50 may be stored in, and/or accessible by, the server 12. The individual patient databases 50 can include a wide variety of information relating to a patient's medical condition, including any one or combination of the following: (a) analyte-concentration measurement values (including, if desired, corresponding dates/times and meter identification information); (b) update status pertaining to the algorithm(s) or software/firmware employed in the meter(s) 14 as discussed above; (c) meter calibration status; (d) physical location of the meter(s); (e) patient exercise data as discussed above; (f) the patient's current height, weight, and/or age; (g) patient diet information as discussed above; (h) patient insulin consumption information as discussed above; (i) patient insurance information; (j) patient disease level classification; (k) current standing orders pertaining to the patient's care and made by a caregiver; (1) rate of use, and/or quantities used, of disposable sample elements. The database 50 may also include second-order information generated by the database(s) 50, 52, such as trends in analyte-concentration measurement values; the patient's exercise, diet, and/or insulin-consumption history; and/or effects of exercise, diet and/or insulin consumption on patient analyte concentration. A caregiver can then sort and/or plot the stored measurement data according to one or more of these data types. For example, if a caregiver wishes to see the frequency of measurement as compared to a variation in analyte concentration, such a plot can be easily derived from the tabulated, stored data.

In one embodiment, a given patient database 50 stores all of the analyte concentration measurement data received by the server 12 from all of the patient-specific meters 14 associated with the patient to whom the database pertains. Alternatively, the patient database 50 can be stored on the patient's personal computer, a patient meter 14, or other device as desired.

With continued reference to FIG. 1, in one embodiment the server 12 generally includes the patient database(s) 50 discussed above, which may contain information specific to each unique patient under management by the system 10, as well as the flexible database 52 which may contain information shared by some or all of the system users. The processing center 54 may be configured to manage user access to the patient databases and/or the flexible database. The processing center 54 can control user authentication and login to create a secure system, to permit only a sufficiently authorized user to view and/or edit information in one or more patient databases 50. In one embodiment, each specific data type stored in a patient database may be assigned one of a number of security levels, so as to allow only users who have a matching or higher security level to view and/or modify a given data type. Additionally, the entire patient management system can be configured to prevent unauthorized users from accessing and/or modifying patient specific data. Such a security system also preferably prevents communications between various management system components from being intercepted by third parties as well as preventing any undesired communications from being sent to any of the system components.

As used herein, “user” is a broad term and is used in its ordinary sense to refer, without limitation, to any person who either inputs information to, or receives information from the presently described patient management system. Users of the present system can include a patient, a primary caregiver, a secondary caregiver, a hospital caregiver, an insurance auditor, a system administrator, etc. The various users can generally be classified into types and may be allowed access to only some of the information contained in one or more of the databases depending on the role of each user in the present system.

Information stored in a specific patient database may be associated with a particular patient by a patient identification number (PIN). Similarly, each patient-specific meter 14 can include a meter identification number (MIN), and can be associated with its owner via the owner's PIN. When a patient-specific meter 14 uploads data to the patient database 50, the server 12 may query the meter for a specific PIN and/or MIN in order to insure that the data being uploaded is stored in the correct patient database 50, and that each measurement is associated with the meter which took it. PINs and MINs can be any suitable alphanumeric, symbolic, binary or other identifier which is sufficiently unique to specifically identify a single patient or meter.

The server 12 can comprise any suitable server hardware, including a purpose-built server system, a personal computer, a storage array, or any combination of suitable hardware components. The server 12 may also include a user interface for allowing a sufficiently authorized user to easily access information contained in the server. A user interface may, in one embodiment, comprise a secure web site accessible by a user via a typical internet connection. Alternatively a server user interface can comprise a self-supporting communication and connection system. In an alternative embodiment, the server 12 can be omitted from the system, and the storage, processing and communications functions of the server can be implemented in other system components, such as the patient meter 14 itself.

The caregiver, insurance-provider and secondary caregiver terminals 16, 20, 46 may comprise any suitable hardware or information appliance, including but not limited to a personal computer, a “dumb” terminal, a personal digital assistant (“PDA”), pager, two-way pager, interactive television device, telephonic audio interface, etc.

In one embodiment, the meter(s) 14 communicate with the server 12 via a connection to a personal computer, which is itself connected to the internet through any suitable data link. Alternatively, the analyte detection meters 14 can be adapted to communicate directly with the server 12 via a wireless connection such as a GSM or cellular network, or via the internet or other proprietary connections such as WiFi®, Bluetooth®, or other wireless data link. Generally, the data paths 30, 32, 34, 36, 38, 40, 42, 44 may comprise any suitable wired or wireless data links, or combinations of wired and wireless data links.

The patient-specific analyte detection meter(s) 14 are generally configured to measure a concentration of one or more analytes, such as glucose, associated with a diabetic condition. The meter(s) 14 can comprise any suitable invasive, minimally invasive, or non-invasive analyte detection device or mechanism. Many such analyte detection systems are known, including electrochemistry-based detection systems, reflectance-spectroscopy-based detection systems, transmission-spectroscopy-based detection systems, etc. Other suitable detection systems include those configured to perform concentration measurements of multiple analytes.

The patient-specific meter(s) 14 used in connection with the patient management system 10 described herein, may also be configured to store and process the resultant analyte concentration measurements. Thus, the meter(s) may include data storage and processing capabilities. Such data storage and processing capabilities can be provided by any suitable processor and storage medium. The meter(s) may be configured to store one or more software algorithms to perform functions such as manipulation or processing of the measurement data obtained by the meter as will be further described below. Thus, a portion of the data storage of the meter can be configured to include a “firmware” storage device which can be provided in addition to a measurement data storage device. Alternatively, a firmware package and the measurement data can be stored on a single piece of hardware. As used herein, the term “firmware” is a broad term and is used in its ordinary sense to refer, without limitation, to one or more strings of computer code which is stored in a read/write memory chip or other updatable data storage device capable of retaining one or more strings of computer code when a power source is disconnected from the device.

Thus, the data storage media (or devices) can include any specific hardware recognized by the skilled artisan as suitable for temporarily and/or permanently storing electronic data. For example, in one embodiment, a ROM chip can be used. Alternatively, a magnetic medium, “smart card,” can also be used as desired, and as needed for a particular set of requirements. The meter(s) may have sufficient storage capacity to store data resulting from at least one day's measurements. As described below, data associated with a single measurement can include a substantial amount of data. Therefore, the storage media used in an analyte-detection meter will typically have at least one megabyte of storage capacity, often at least five megabytes. Of course the skilled artisan will recognize that additional storage capacity beyond these values may also be needed, thus the maximum storage capacity of an analyte detection meter should only be limited by the state of the art of data storage technology. Alternatively still, even smaller storage devices can be provided with as little as 100 bytes or less of storage space depending on the needs of a particular meter.

A data processor may be employed in the meter(s) 14, as described below, to execute various algorithms as further discussed herein, including digital code for manipulation and/or processing of the measurement data, and/or for facilitating communication between the meter and another digital system. Thus, the data processor is typically capable of performing at least one million calculations per second, often at least 10 million calculations per second. Of course the skilled artisan will recognize that processing speed beyond these values may also be needed, thus the processing speed of an analyte detection meter should only be limited by the state of the art of data processing technology. Alternatively still, substantially low-speed processors can also be used as desired.

The meter(s) may also include a user interface with any of a variety of input and output devices for allowing a user to input information to, and to receive information output by the meter 14. The user interface can include a visible display such as a liquid crystal display, a field emission display, or any other graphic display system or device. Alternatively or in addition, the meter output device can comprise an audio, or tactile output device as desired. The user interface may also comprise any components suitable for entering any of the data 30 described herein as flowing from the patient to the meter. For example, a user interface can employ devices such as a keyboard, a touch screen, a bar code reader, an RFID device, or any other device capable of inputting relevant information to the meter.

In one embodiment, a user interface for an analyte detection meter comprises a series of prompts for information from the patient prior to performing a calculation. For example, a user interface may request information such as a size of, or a quantity of carbohydrates in, a meal to be consumed by the patient; a time at which such a meal was or is to be consumed; an exercise level; a type or brand of insulin used by the patient; a method of insulin consumption used by the patient; etc. Any or all of such information, or any of the data 30, can be displayed to the patient as options to be selected from a list. Alternatively, such information can be individually input via an alphanumeric input device (e.g. a keyboard, etc.).

In one embodiment, any one or combination of the analyte detection meter(s) 14, 18 can be configured to interface with a pump or other device for measuring and/or delivering a medicine, such as insulin. For example, a meter 14/18 can be configured to interface with an insulin pump by equipping the meter with a suitable pump interface and software algorithm to control a basal and/or bolus insulin dosage delivered by the insulin pump. In an alternative embodiment, any one or combination of the meter(s) 14, 18 can be configured to interface with an insulin pen by providing the meter with a suitable pen interface and software algorithm to control a basal and/or bolus insulin dosage delivered by an insulin pen. In these embodiments, any suitable insulin pump or pen may be employed.

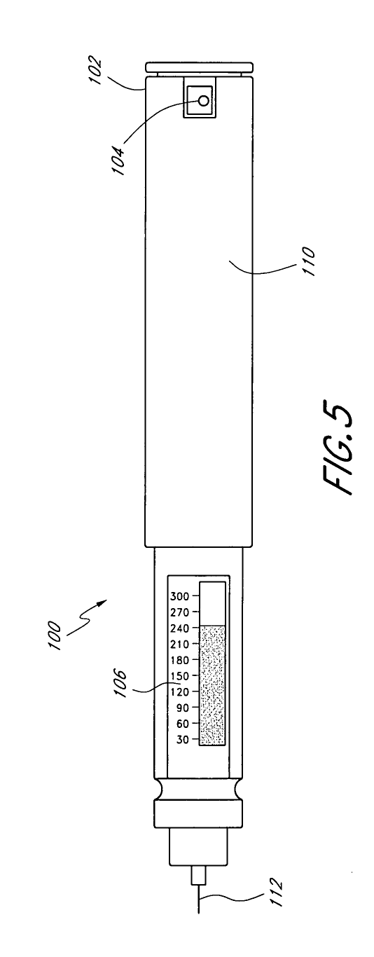

One embodiment of a standard insulin delivery pen is illustrated in FIG. 5. The illustrated insulin pen 100 is of a type commonly available, and includes a dosage selection knob 102, a dosage dial indicator 104, and a graduated indicator window 106. In operation, the knob 102 is rotated relative to the main body 110 of the pen 100 in order to select a desired insulin dosage. That the proper dosage has been selected can be visually verified by a user by looking at the dosage dial indicator 104 which indicates a dosage in “units” of insulin and/or by looking at the graduated indicator window which indicates an insulin dosage in cc's, ml, or any other convenient volumetric unit. Once the proper dosage has been selected, the insulin can be delivered to the patient through the needle 112.

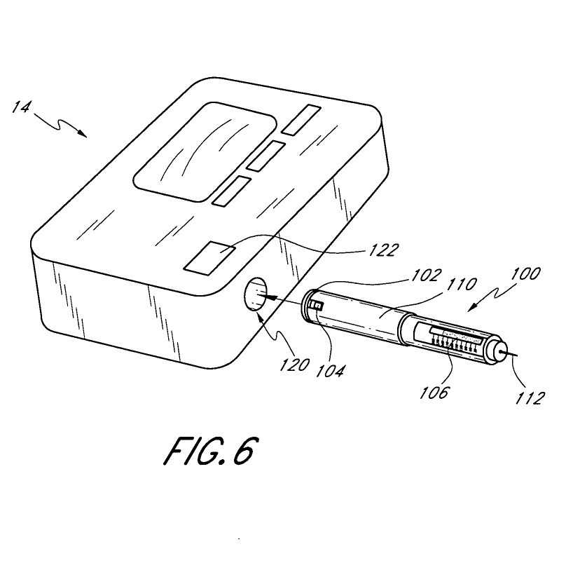

One embodiment of a meter 14 configured to mechanically interface with an insulin delivery pen 100 is shown in FIG. 6. In the illustrated embodiment, the meter 14 comprises an interface port 120 for receiving the knob end of the insulin pen 100. In one embodiment, the interface port is generally configured to engage the main body 110 of the insulin pen 100, and to rotate the knob 102 to obtain a desired dosage (e.g., a dosage computed pursuant to a correction algorithm executed by the meter 14 and/or server 12 as discussed herein).

In one embodiment, the port 120 can be configured with a proximity switch, etc. to sense the insertion of an insulin pen 100 therein, at which point a clamp can close on the main body 110 of the pen 100 in order to hold the main body 110 of the pen 100 stationary. Such a clamp can comprise one or more radially movable members actuated either manually or automatically. The port 120 can also be configured to engage and rotate the knob 102 relative to the pen body 110. In one embodiment, the port comprises a wheel configured to be placed in contact with the knob. Such a wheel can be actuated by a stepper motor, a servo motor or other suitable controllable actuator.

In one embodiment, the selection of the desired dosage via the port 120 can be visually verified by a user by looking at one of the indicators on the pen. Alternatively, the meter can be further configured to optically read the dosage dial indicator 104 and software can be provided to identify the value of the numerical dial indicator 104. In still another embodiment, the meter can be provided with a visual indicator 122 which indicates to the patient that the proper dosage has been selected, and that the pen is ready to be used. The visual indicator 122 can include an suitable means including (but not limited to) an LED or other light, a colored flag, or a transparent window through which the user can read the dial indicator 104. In one embodiment, the visual indicator comprises a transparent window with a magnification lens to allow a patient to more easily read the dial indicator 104.

In an alternative embodiment, an insulin pen can be configured to interface with a meter 14/18 in a non-mechanical manner. In such an embodiment, the insulin pen itself can be provided with sufficient actuators and feedback control to allow the pen to automatically select a dosage based on a signal received from the meter. For example, in one embodiment, the meter can take an analyte measurement, calculate a desired correction bolus (based on, e.g., a correction algorithm executed by the meter 14 and/or server 12 as discussed herein), and then communicate the correction bolus to the pen. The pen can then automatically make available the correction bolus to be delivered to the patient. According to this embodiment, the correction bolus information can be communicated to the pen via any suitable wired or wireless means, including various proprietary and other communications systems such as GSM, WiFi, Bluetooth, or any hardwired data link.

In still another embodiment, the insulin pen itself may include an onboard processor, memory, etc. to compute a correction bolus by executing a correction algorithm in the same manner as the meter or server, as is discussed in further detail below. Such an insulin pen may connect to the patient management system 10 directly, through the meter 14/18 or via any suitable alternative path, to receive updated correction algorithm(s), and/or the current values of the variables employed in the algorithm(s) from the server 12, caregiver terminal 16, and/or meter(s) 14/18. The algorithm(s) and variables employed may comprise any of the algorithms or variables discussed herein. Upon computing a correction bolus, the insulin pen makes the correction bolus available to the patient for subsequent injection/consumption, by displaying the appropriate bolus to the patient, who then manually sets the pen to deliver the displayed bolus, or by automatic dosage selection and adjustment as discussed above. In one embodiment, such an insulin pen can have a modular configuration, with the processor, memory, display and/or other electronics, and any mechanical actuators, contained in a reusable module and the insulin and needle contained in a second, disposable module which interfaces with the reusable module.

One advantage to automating an interface between an insulin delivery pen and an analyte detection meter is the reduction of errors associated with a patient mistakenly selecting too large or too small a dosage on the pen. The dosage calculations are preferably performed by the analyte detection meter or the pen itself as described elsewhere herein in order to remove the possibility of human error in performing the correction dosage calculation. By automating the calculation of a correction bolus dosage and the communication of the proper dosage to an insulin delivery device (e.g. an insulin pen), the human error element can be substantially reduced, thereby allowing for more consistent control of a patient's diabetic condition.

As will be clear to the skilled artisan, the meter 14 and insulin pen 100 combination described above can be used independently of other components of a patient management system described herein. For example, in one embodiment, schematically illustrated in FIG. 1A, the storage, processing, and communications functions performed by the server 12 can be implemented in the meter 14, thereby allowing the server 12 to be eliminated. Thus, the remaining elements of the patient management network 10a, including for example: a home meter 14h, a hospital meter 18, a primary caregiver 16, a secondary caregiver 46, an insurance company 20, or other patient meters 14 (any or all of which can be omitted) can communicate directly with the patient meter 14 via any suitable means.

The meter(s) 14 may also be configured to interface with a personal computer to allow a patient to store the contents of the digital memory of the meter on the computer, and/or to allow the meter to interface with other electronic systems through the computer. Such an interface between a computer and a detection meter can comprise any hardwired connection such as USB, serial, parallel, SCSI, etc. Alternatively, a meter can be configured to interface with a personal computer via a wireless communication system such as infrared or RF. Additionally, if desired, an analyte detection meter can be configured to interface with other analyte detection meters via any suitable hardwired or wireless connection.

A home-based patient-specific meter 14h may include components similar to those described above in relation to handheld/portable patient-specific meters 14. By comparison, a home meter may include a larger display, a larger digital storage capacity, and may include a more accurate analyte concentration measurement device. As with the meter(s) 14 in general, the home-based meter 14h may employ any analyte-concentration measurement technology recognized as suitable.

A hospital-based analyte detection meter 18 may include components similar to those described above in relation to handheld 14 and home-based 14h analyte detection meters. A hospital-based detection meter 18 may include sufficient data storage capacity for a plurality of patients, and may have a higher measurement accuracy than the patient-specific meters. The hospital-based meter 18 may be in communication with the server 12 via a hardwired internet connection, or other communications network. The hospital-based meter 18 can also have an interface for communicating with a handheld detection meter 14 in order to download patient-specific information from the handheld patient meter 14.

A caregiver authorized to treat a particular patient is preferably able to access that patient's information in the server 12 via the caregiver terminal 16. The caregiver terminal 16 can comprise any suitable electronic device for providing a user interface between the caregiver and the data contained in a patient database 50. For example, a caregiver terminal can comprise a personal computer connected to the central server via the internet, a personal digital assistant (PDA) device configured to be in communication with the server, a “dumb” terminal, two-way pager, telephonic audio interface, or any other digital communications device.

In one embodiment, the meter(s) include a real-time clock, and remind the patient to take blood-analyte measurements several times throughout the day. In one preferred embodiment, the meter reminds the patient to take measurements during wake hours only. The real-time clock allows for time data and time interval data to be stored automatically. In one embodiment, in the exemplary context of blood-glucose management, the patient can take a glucose measurement in response to the reminder by the meter. In some embodiments, the real-time clock is configured to be automatically-updatable so as to account for differences in changes in time-zone during travel.

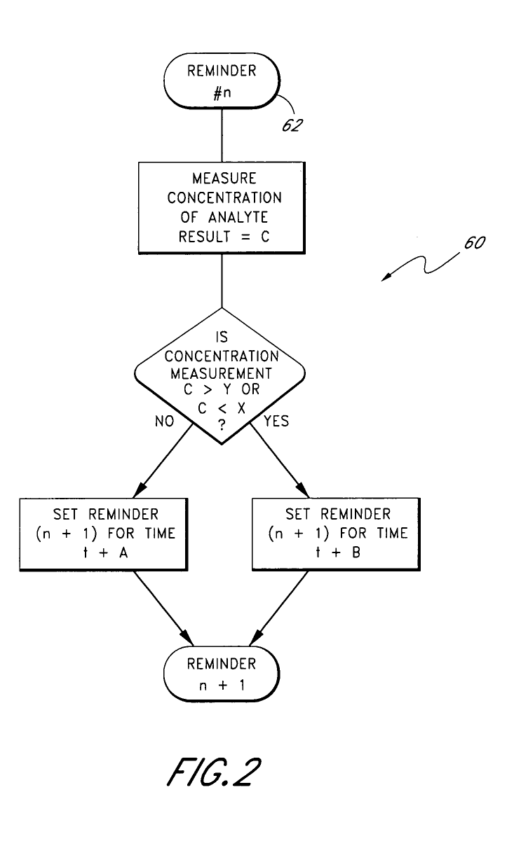

Embodiments of software which may be implemented in and executable by analyte detection meter(s) 14 will now be described with reference to FIGS. 2-4. The following embodiments of software algorithms can be stored as program instructions in the memory of any of the meter(s) 14 disclosed herein, including handheld patient-specific meters, home-based patient specific meters, hospital-based meters, as well as a central server, or any other appropriate digital system or computing device in communication with the patient management system 10.

One embodiment of an adaptive reminder routine 60 is schematically illustrated in FIG. 2. In the depicted embodiment, the routine 60 compares a concentration measurement C against one or more reference values X or Y, to determine whether a following measurement should be scheduled according to a regular measurement interval, or a shortened interval. A first reminder 62 alerts a patient to perform an analyte concentration measurement at time t. The patient then utilizes the meter to measure a concentration C of a diabetic-related analyte present in the patient. The meter then compares the measured concentration C with upper X and lower Y reference values. If the measured concentration value C falls within the range defined by the upper X and lower Y reference values (i.e. if both of the conditions C>Y and C<X are true), then the routine schedules a next reminder (n+1) at a regular measurement interval A by adding the interval A to the current time t. Alternatively, if the measured concentration value C falls outside of the range defined by the upper X and lower Y reference values (i.e. if at least one of the conditions C>Y and C<X is false), then the adaptive reminder routine sets the next reminder (n+1) at shortened interval B by adding the interval B to the current time t.

The embodiment of FIG. 2 employs a single range of reference values X, Y associated with a single or uniform shortened measurement interval and a single or uniform regular measurement interval. In alternative embodiments, the adaptive reminder routine 60 can further include additional reference values associated with additional shortened, lengthened, or ‘regular’ measurement intervals as desired by a caregiver for optimal management of a patient's diabetic condition. The reference values and the measurement intervals may be determined by a primary caregiver to correspond to the severity of a patient's diabetic condition. For example, in a case of a particularly brittle diabetic patient, a reminder routine may comprise a lower reference value of about 68 mg/dL, an upper reference value of about 200 mg/dL, a regular measurement interval of about 2 hours, and a shortened measurement interval of about 0.5 hours.

In one embodiment, in which the medical condition is diabetes, the meter is configured to remind the patient to take analyte measurements 6-8 times during the patient's waking hours. For example the meter may, pursuant to the routine 60, remind the patient to take analyte-concentration measurements: upon waking up; upon eating breakfast; before lunch; after lunch; before dinner; after dinner; and at bedtime. The actual times or events during/before/after which the meter reminds the patient to take measurements can vary depending on various factors, such as, for example, the patient's habits and lifestyle. Measurements can be prompted and taken more frequently (i.e. more than 6-8 times per day) when more intensive management is required. In one embodiment, in the context of intensive blood-glucose concentration management, the patient's blood-glucose concentration is measured frequently at regular time intervals of about two to three hours. In another embodiment, the blood-glucose concentration of the patient is measured more frequently at non-regular time intervals which can be adaptively determined by the routine 60 as described above.

Whether implemented as depicted in FIG. 2 or otherwise, the reminder routine provides scheduled reminders to the patient requesting that the patient take a concentration measurement of a particular analyte. The reminder routine can be configured to signal a patient by causing the meter to emit an audible, visible, and/or tactile alert signal which can be heard, seen and/or felt by the patient. The reminder routine can be configured to alert a patient of a scheduled measurement at regular intervals, such as one reminder every three hours, etc.

In one embodiment, the reminder routine can be modified by a patient or by a caregiver, or by an update routine in the central server 12. Such an update routine can be remotely modified by a primary caregiver from the caregiver's terminal 16.

In other embodiments, the meter and/or server may be configured to determine when to remind the patient to take analyte measurements by taking into consideration the current analyte-concentration level, a targeted analyte-concentration level, recently measured analyte-concentration maxima and minima, etc. The meter/server may compile any one or combination of these data into a case history of the patient's analyte-concentration level and adjust, based on the case history, the times at which it reminds the patient to take an analyte measurement. In one embodiment, the meter/server can utilize fuzzy logic and/or other predictive analysis methods known in the art to determine, based on the case history and/or other data, when it should remind the patient to take analyte measurements. This can require storing and processing large amounts of data; thus, in some cases, such predictive analysis calculations can be performed by the server using the information contained in the patient database. The processed information can then be transmitted back to the meter for use by the meter in correction bolus calculations, or other calculations. In another embodiment, the meter also utilizes fuzzy logic and/or other predictive analysis methods known in the art to determine what the target analyte level should be. This target value is then provided to the caregiver who can consider the suggested target value when making the decision as to what the patient's target analyte concentration should be.

In support of the reminder routine 60 and/or other functions of the meter 14, a time-keeping algorithm, or clock algorithm may be employed to track a time and date for each unique analyte concentration measurement taken by a meter. If time and date information are not accurately set in the meter (or elsewhere in the system 10), or are otherwise not kept in the meter/system, the clock algorithm can conduct time calculations relative to an arbitrary reference time, rather than an absolute or “real” time (i.e. a time measured from GMT). Once a date and time information is updated, any readings recorded relative to a reference time can, if desired, be updated to reflect the actual local time and date.

In one embodiment of the patient management system described herein, a correction algorithm may be implemented (as software, program instructions, etc.) in one or more of the meter(s) 14 and/or the server 12. The correction algorithm, and/or various associated methods, may be employed to maintain a patient's analyte concentration level at basal or normal levels. The correction algorithm calculates or determines a correction bolus to be consumed and/or executed by the patient to raise, lower, or otherwise affect the patient's analyte concentration level.

In various embodiments, the correction algorithm may compute or determine a correction bolus based on one or more variables, which may include patient-affected variables and/or caregiver-affected variables. Patient-affected variables may include (but are not limited to) the patient's: height, weight, age, exercise level, diet, analyte concentrations (e.g., glucose, ketones, HBA1C), and other factors which may affect a patient's blood-glucose level and which can be quantified to a sufficient degree of accuracy by a patient. Caregiver-affected variables may include (but are not limited to) clinically-determined adjustment factors such as a patient's: Total Daily Dose (“TDD”) of insulin; Insulin Adjustment Factor (“IAF”); Insulin Sensitivity Factor (“ISF”); target level of blood glucose; frequency of analyte-concentration measurements (or interval between measurements); and analyte type to be tested for.

Generally, caregiver-affected variables include those variables which are determined by a caregiver with clinical training. The various adjustment factors discussed herein are usually determined by a caregiver based on a number of data, including at least some of the patient-affected variables available to the caregiver via the patient management system.

The Total Daily Dose (“TDD”) of insulin, mentioned above, is generally a total number of units of insulin which a patient should consume in a given 24-hour period. The TDD is typically determined based on a patient's weight as well as other factors. For example, many type 1 diabetics have TDD's of 0.5 to 1.0 units/kg/day.

The Insulin Adjustment Factor (“IAF”), also mentioned above, is typically expressed in units of insulin required per gram of carbohydrates consumed, and is generally determined to correspond to a patient's metabolism. For example, most patients use an IAF value of 1 unit of insulin per 10 g to 15 g of carbohydrates; however, some particularly active patients might use one unit per 25 g of carbohydrates.

The Insulin Sensitivity Factor (“ISF”), also mentioned above, is a measure of a patient's sensitivity to insulin, i.e. how much a patient's blood glucose concentration is decreased by the introduction of a single unit of insulin. ISF values are generally expressed in units of insulin per (mg/dL) change in glucose concentration. ISF values can be determined by dividing a patient's Total Daily Dose by a constant supplied by the insulin manufacturer. Thus, the ISF is largely affected by the brand and/or potency of insulin used by a patient as well as by a patient's biological factors.

The target level of blood glucose concentration, also mentioned above, is determined by a caregiver in order to maintain a patient's blood glucose levels as close to “normal” as possible while minimizing instances of hypoglycemia (blood-glucose deficiency) or hyperglycemia (excessive blood-glucose). The degree of variation from the target value is largely dependent on the degree of intensity of the control system including frequency of measurements and corrections.

It should be noted that the foregoing variables are merely provided as examples, and that many more caregiver-affected variables can also be employed in a correction algorithm. Additionally, any specific values of caregiver-affected variables may be determined by a caregiver for a specific patient, and the above values are merely intended as general examples.

It should also be noted that some patient-affected variables typically exhibit higher rates of change than other patient-affected variables; thus, the slowly-changing variables (such as body weight, etc) may not need to be updated as frequently as the faster-changing variables, such as the concentrations of specific analytes (such as glucose in the case of a diabetic condition), or short-term changes in diet or exercise.

One example of a correction algorithm for calculation of a pre-meal insulin dose comprises:
Retrieving values of: carbohydrates to be consumed in the meal (Cc), Insulin Sensitivity Factor (ISF), Insulin Adjustment Factor (IAF), Target Glucose Concentration (G_{target}), and a recent pre-meal Measured Glucose Concentration (Gₘₑₐₛ).
Calculating a pre-meal insulin dose (D) using the equation:
   D=IAF*CC+ISF*(Gmeas−Gtarget)

Many other correction algorithms can alternatively be used in appropriate situations to determine a correction bolus for the patient, and/or to maintain the patient's blood glucose concentration within an acceptable degree of variance from a target value. For example, physicians often develop correction algorithms specifically suited to a particular patient or a group of patients. Any suitable correction algorithm can be stored in, and/or executed by, the meter(s) 14 and/or server 12, for calculation/determination of an appropriate correction bolus based on the relevant patient-affected and/or caregiver-affected variables. As used herein, “correction algorithm” is a broad term and is used in its ordinary sense to refer to any method employed to compute or otherwise determine a correction bolus. Correction algorithms may be computational or non-computational, and may be implemented via digital or analog electronics, or performed by hand.

In one embodiment, the execution of the correction algorithm by the meter and/or server merely automates calculations which would otherwise be performed by a patient to determine a correction bolus of insulin to be taken before or after a meal, exercise, or other event which may affect blood glucose levels.

As used herein, the term “correction bolus” is a broad term and is used in its ordinary sense to refer, without limitation, to any course of action to be taken by a patient to adjust his/her blood-analyte concentration. For example, in the context of controlling a patient's blood-glucose concentration, the correction bolus can comprise one or more of: consumption of insulin (e.g, by injection, oral consumption, transdermal patch, etc.). As used herein, the term “material sample” (or, alternatively, “sample”) is a broad term and is used in its ordinary sense to refer, without limitation, to any collection of material which is suitable for analysis by the analyte detection system 10. For example, a material sample may comprise whole blood, blood components (e.g., plasma or serum), interstitial fluid, intercellular fluid, saliva, urine, sweat and/or other organic or inorganic materials, or derivatives of any of these materials. Where the meter in use is noninvasive, the material sample may comprise a portion of the patient's body placed against or into operative engagement with the meter, without removal of such portion from the patient's body.

One or more correction algorithms may be implemented in the patient management system, or in any similar system, as follows. The correction algorithm(s) may be stored as program instructions, software, etc. in memory in the meter(s) 14 or the server 12, or may be distributed between the memory of the meter(s) and that of the server. Multiple correction algorithms (e.g., correction algorithms for different purposes such as computation of an insulin dose or other factors) may be stored in each of the meter(s) and/or server. Similarly, the correction algorithm(s) may be executable by processor(s) contained in either or both of the meter(s) and the server.

Similarly, the values of the variables (e.g., any of the patient-affected variables or caregiver-affected variables discussed herein) employed in the correction algorithm(s) may be stored in memory in the meter(s), or in the server, or distributed between the memory of the meter(s) and the memory of the server.

In one embodiment, the correction algorithm(s) themselves may be installed, modified, updated and/or removed by a caregiver, whether the algorithm(s) reside in the meter(s), in the server, or in both. To so install/modify/update/etc., the caregiver may access the server 12 and/or meter(s) 14 via the caregiver terminal 16 and operate the terminal in the appropriate manner to complete the installation/modification/update/etc. When such an installation/modification/etc. is being executed, the data flow 38 from the server 12 to the caregiver terminal 16, and/or the data flow 34 from the meter(s) 14 to the server 12, may comprise an update status of the correction algorithm(s) of interest in the devices of interest, and/or a list of the correction algorithms stored in the devices of interest. The data flow 40 from the caregiver terminal 16 to the server 12, and/or the data flow 36 from the server 12 to the meter(s) 14, may comprise a new/additional correction algorithm, an update or modification to an existing correction algorithm, or a command to delete a particular correction algorithm. In one embodiment, the caregiver may modify/update a correction algorithm by changing an mathematical operator within the algorithm.

In another embodiment, the values of any one or combination of the caregiver-affected variables employed in the correction algorithm(s) may be modified or updated by a caregiver, whether the values reside in the meter(s), in the server, or in both. To so modify/update, the caregiver may access the server 12 and/or meter(s) 14 via the caregiver terminal 16 and operate the terminal in the appropriate manner to complete the modification/update. When such an installation/modification is being executed, the data flow 38 from the server 12 to the caregiver terminal 16, and/or the data flow 34 from the meter(s) 14 to the server 12, may comprise a current status/value of the variable(s) of interest in the devices of interest, and/or a list of the variable(s) stored in the devices of interest. The data flow 40 from the caregiver terminal 16 to the server 12, and/or the data flow 36 from the server 12 to the meter(s) 14, may comprise a new/updated value of the variable(s) of interest.

In another embodiment, the values of any one or combination of the patient-affected variables employed in the correction algorithm(s) may be modified or updated by the patient, whether the values reside in the meter(s), in the server, or in both. To so modify/update, the patient may simply take an analyte-concentration measurement in the usual manner (e.g., to update the current concentration of the analyte in question), input changes in height/weight/age/exercise/diet data into the meter 14 via a suitable user interface incorporated into the meter, etc. Depending on the storage location within the system 10 of the variable(s) in question, the data flow 30 from the patient 22 to the meter(s) 14, and/or the data flow 34 from the meter(s) 14 to the server 12, may comprise a new/updated value of the variable(s) of interest.

As mentioned above, any of the correction algorithms may be executed in the meter(s) 14 and/or in the server 12. Accordingly, a correction bolus calculated or determined by the correction algorithm may be reported to the patient and/or caregiver by passing the bolus along the system 10 as part of the data flow 36 from the server 12 to the meter(s) 14, the data flow 38 from the server 12 to the caregiver terminal 16, and/or the data flow 34 from the meter(s) 14 to the server 12, depending on the location of the execution of the correction algorithm.

In various embodiments, the system 10 is configured to report selected data to the caregiver via the caregiver terminal 16, to enable the caregiver to precisely manage the patient's condition. The meter(s) 14, server 12, and/or caregiver terminal 16 (or other appropriate elements of the system 10), or any appropriate combination thereof, may be configured to pass the selected data to the caregiver. The data so passed to the caregiver may comprise any one or combination of: (a) analyte-concentration measurement values; (b) trends in analyte-concentration values; (c) analyte-concentration measurement values which fall outside of a specified safe range; (d) correction bolus computed by the correction algorithm(s) and/or consumed by the patient; (e) any of the variables employed in the correction algorithm(s); (f) any of the data in the database(s) 50, 52.

In one embodiment, a caregiver or other personnel may configure or customize the meter(s) 14 associated with a particular patient, to report one or more selected diabetes-relevant data to the caregiver. The meter(s) 14 may report the selected data regularly through the server 12 and caregiver terminal 16 of the patient management system 10. Upon association of the meter(s) 14 with the patient (e.g., when a new meter is purchased or provided, or when the patient is placed under management by the system 10), the meter 14 may be configured to report selected data to the caregiver by allowing the caregiver, via an appropriate user interface of the meter and/or caregiver terminal, to choose one or a combination of the various data that the meter can report to the caregiver. As discussed above, the reportable data may comprise any one or combination of: (a) analyte-concentration measurement values; (b) trends in analyte-concentration values; (c) analyte-concentration measurement values which fall outside of a specified safe range; (d) correction bolus computed by the correction algorithm(s) and/or consumed by the patient; (e) any of the variables employed in the correction algorithm(s); (f) any of the data in the database(s) 50, 52. In further embodiments, the caregiver may alter the operation of the meter by installing/updating/etc. the correction algorithm(s) or the caregiver-affected variables as discussed above. The caregiver may do so in response to, or based on, the data that is reported to the caregiver by the meter (e.g., where a particular datum is outside a safe range, etc.).

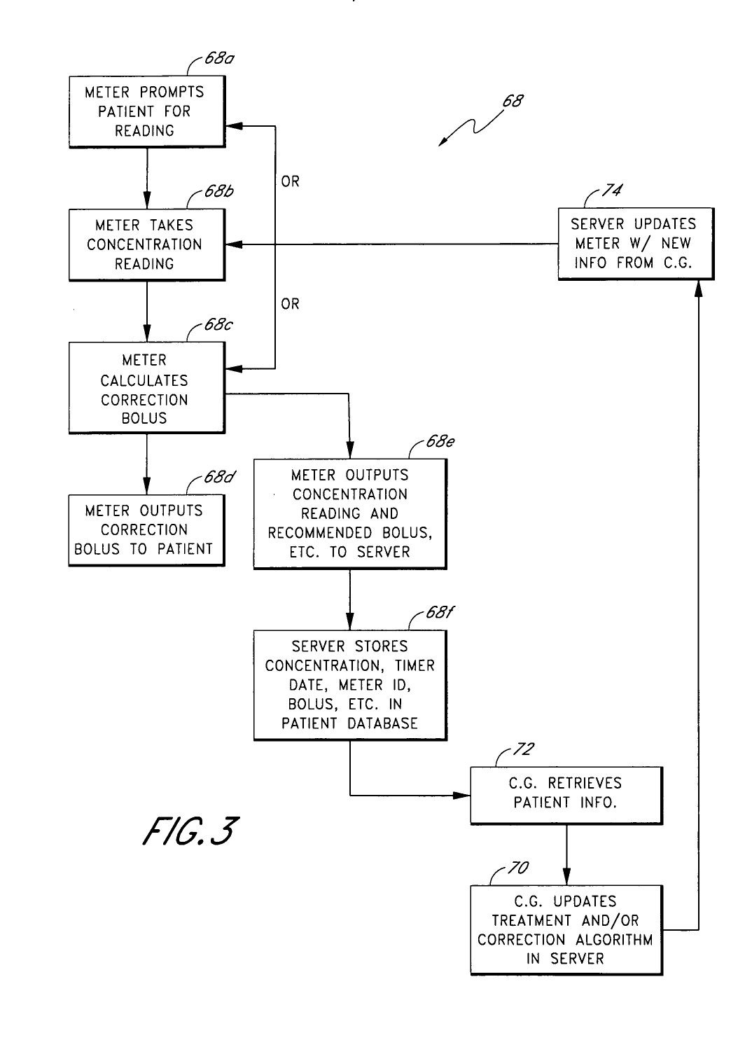

FIG. 3 illustrates one embodiment of an update routine 68 in which a caregiver (C.G.) is involved via the patient management system 10 and appropriate configuration of the patient's meter(s) 14. The routine 68 may begin in any of states 68a, 68b, 68c, in which the meter computes a correction bolus by executing an appropriate correction algorithm, which may occur in response to the taking of a concentration reading 68b, which may in turn occur in response to a reading prompt 68a. The meter reports the correction bolus and analyte concentration to the patient 68d so that the patient may consume or otherwise execute the bolus. The meter also reports 68e the correction bolus, analyte concentration, time/date, meter ID, etc. to the server 12, which stores 68f these data in the appropriate patient database 50. The caregiver may then retrieve 72 any one or more of these data from the patient database (or, alternatively, the system may be configured to “push” the data to the caregiver). Based on the accessed data, the caregiver may update 70 in the server the correction algorithm(s) and/or the variables employed therein. The server may in turn execute 74 these update(s) in the meter(s) themselves, so that they will take effect for the next measurement cycle.

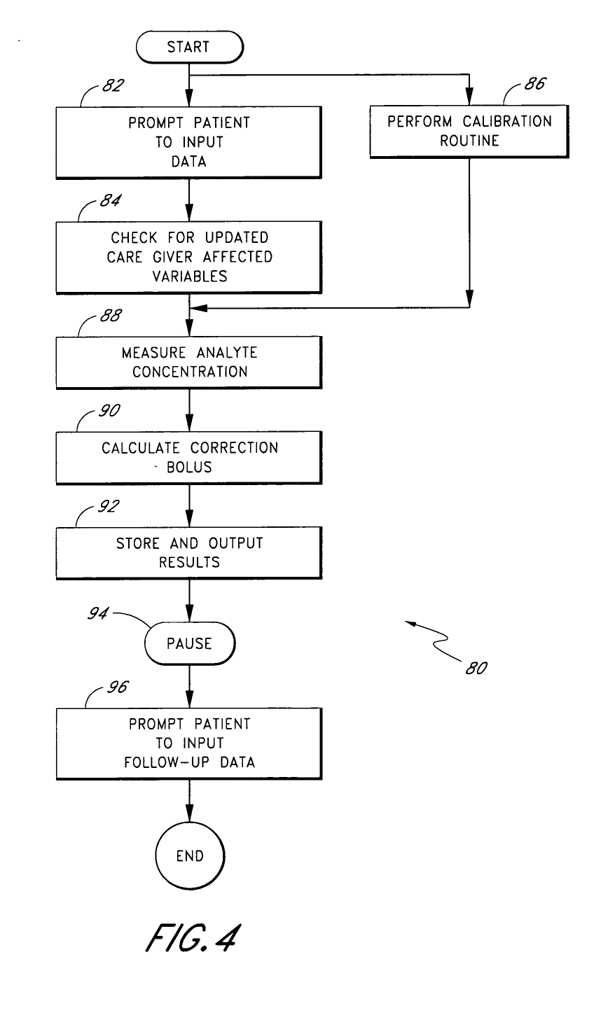

FIG. 4 illustrates one embodiment of a measurement cycle 80 in which a patient is prompted 82 to input one or more patient-affected variables. The meter then checks 84 its stored data for updated caregiver-affected variables. If desired, a meter can be configured to perform a calibration routine 86 in parallel with these steps prior to a measurement step 88. The meter then measures 88 the concentration of the analyte in the provided sample, and calculates 90 a correction bolus based on the stored variables and the measured analyte concentration. The results of the measurement are then at least temporarily stored 92 in the meter (before being later sent to the patient database in the central server). The meter can then be configured to pause 94 for a few minutes, or longer and to eventually prompt 96 the patient to input follow-up information such as a dosage of medication consumed, or other treatment related information.

In one embodiment, the meter may have an on/off switch with which to activate/deactivate the correction bolus calculation. In keeping with certain of the embodiments described herein, the caregiver may determine whether or not to activate the correction algorithm in a patient's meter. If the correction algorithm is deactivated in a patient's meter, the meter may be configured to report only glucose concentration measurements, and may also be configured to remind the patient of scheduled measurements.

In one embodiment, blood-glucose measurements provided by the meter over the patient management system can be used to expedite and/or supplement hospital protocols for monitoring and/or treating patients. For example, in a situation where a patient at a hospital is experiencing a hyperglycemic episode, such as, for example a blood-glucose level equal to or exceeding 520 mg/dL, it is common hospital protocol to draw blood from the patient and send the blood sample to a laboratory for analysis. In another embodiment, the patient-specific meters may serve as portable medical record, providing information such as analyte and time data values, with which physicians and hospitals can provide improved treatments for patients.

Additionally, as described above, the hospital meter 18 may be in electronic communication with the portable patient-specific meter(s) 14 and the server 12 as illustrated in FIG. 1. Thus, a hospital staff can be provided with patient-specific medical history relating to the patient's condition.

As discussed above, an insurance provider may be granted limited access to a patient's database 50 via the insurance-provider terminal 20 such that the insurance provider may only view information relating to a patient's compliance with a particular treatment program. For example, if a disposable sample element is needed for individual analyte-concentration measurements, the meter(s) 14 and/or server can be configured to keep track of a number of sample elements consumed, and this information can be made available to the insurance provider for billing and/or reimbursement purposes.

A system administrator will typically not have access to any patient's database beyond what is necessary for maintaining the integrity of the system. For example, a system administrator may need to modify or correct errors in a particular section of the system. Additionally, in the interest of maintaining the security of the patient's records as well as the desire to prevent malicious tampering with the system by third parties, an appropriate security system is preferably implemented in the patient management system. The skilled artisan will recognize that many suitable methods of implementing such security systems are available and/or can be customized to suit the needs of a particular patient management system.

Although certain embodiments and examples have been described herein, it will be understood by those skilled in the art that many aspects of the methods and devices shown and described in the present disclosure may be differently combined and/or modified to form still further embodiments. For example, the skilled artisan will recognize that various sub-combinations of elements described above can be used or practiced independently of other elements of the system or methods of which they form a part. For example, a patient meter having any of the features described above can be used alone or in combination with an insulin delivery device and independently of other elements of a patient management system. Additionally, it will be recognized that the methods described herein may be practiced using any device suitable for performing the recited steps. Such alternative embodiments and/or uses of the methods and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

1. A method of managing a diabetic condition comprising;
configuring a meter to calculate a correction bolus using a correction algorithm;
further configuring the meter to measure a concentration of an analyte in a material sample from a patient, said analyte being an indicator of a diabetic condition, a result of said measurement being a variable used in said correction algorithm;
providing a server in two-way communication with said meter;
configuring said server to store information received from said meter;
allowing a medical caregiver to access the server using a terminal in two-way communication with said server; and further allowing the medical caregiver to modify said correction algorithm via said terminal.

2. The method of claim 1, wherein variables used by the correction algorithm to calculate the correction bolus comprise patient-affected variables, and caregiver-affected variables.

3. The method of claim 2, wherein modifying said correction algorithm comprises at least one member of the group consisting of:
changing a value of a caregiver-affected variable;
changing a mathematical operator in said correction algorithm;
changing a time interval between prompts from the meter for measurements; and
requesting an additional measurement.

4. The method of claim 2, wherein modifying said correction algorithm comprises changing a value of a caregiver-affected variable, said caregiver-affected variable being selected from the group consisting of a correction factor, a target analyte concentration.

5. The method of claim 1, further comprising allowing the care giver to request additional action from the patient via the meter.

6. The method of claim 5, wherein requesting additional action comprises requesting a measurement of a ketone body or requesting a measurement of HBA1C.

7. The method of claim 2, wherein the patient-affected variables comprise one or more members of the group consisting of: a measured glucose concentration, a measured HBA1C concentration and a measured ketone concentration.

8. The method of claim 2, wherein the caregiver-affected variables comprise one or more members of the group consisting of: a target glucose concentration, a correction factor, a time interval between measurements.

9. The method of claim 1, wherein the meter is a handheld meter.

10. A method for communicating patient information to a caregiver for use in managing a diabetic condition of a patient, said method comprising:
providing a meter configured to measure a concentration of an analyte and to at least temporarily store the results of said measuring;
associating said meter with said patient;
configuring said meter to communicate to said caregiver by presenting to said caregiver a choice of at least one diabetes-relevant datum for communication by said meter to said caregiver.

11. The method of claim 10, wherein said at least one diabetes-relevant datum is a member of the group consisting of:
an individual value of a concentration of an analyte relevant to said diabetic condition;
trends in individual values of analyte concentrations;
individual analyte concentration measurement results which lie outside of a pre-determined range of values;
a correction bolus consumed by said patient.

12. The method of claim 11, further comprising configuring said meter to receive a communication of a datum from said caregiver.

13. The method of claim 12, wherein said datum communicated from said caregiver to said meter is at least one member of the group consisting of:
a numerical value used by an algorithm to calculate a correction bolus;
a request for an additional concentration measurement; and
a request for a measurement of a secondary analyte.

14. A method for communicating patient information to a caregiver for use in managing a diabetic condition of a patient, said method comprising:
providing a server configured to communicate with at least one patient-specific meter;
presenting to said caregiver a choice of at least one diabetic-specific datum for communication from said patient-specific meter to said caregiver; and
implementing said choice via said server.

15. The method of claim 14, wherein said implementing comprises configuring said meter to send said at least one diabetic-specific datum to said server, and configuring said server to send said at least one diabetic-specific datum directly to the caregiver.

16. The method of claim 14, wherein said implementing comprises configuring said meter to send said at least one diabetic-specific datum directly to the caregiver.

17. A method of managing a diabetic condition by placing a medical caregiver in electronic communication with a diabetic patient via a communications network, the method comprising:
providing a server having storage and processing capabilities;
providing at least one patient-specific meter configured to measure a concentration in a diabetic patient of at least one analyte associated with diabetes, said meter being further configured to calculate a correction bolus based on said concentration of said at least one analyte;
providing a communication terminal for said caregiver;
communicating at least one datum relating to said diabetic condition from said meter to said caregiver;
communicating at least one datum relating to said correction bolus from said caregiver to said meter.

18. The method of claim 17, wherein the terminal for said caregiver comprises a personal digital assistant running a software program configured to communicate with the meter.

19. The method of claim 17, wherein the terminal for said caregiver comprises a desktop or laptop computer running a software program configured to communicate with the meter.

20. The method of claim 17, wherein said at least one datum communicated from said caregiver to said meter comprises a variable used by said meter to calculate said correction bolus.

21. The method of claim 17, further comprising a terminal for a secondary caregiver, and communicating at least one datum relating to said diabetic condition from said meter to said secondary caregiver.

22. The method of claim 17, further comprising configuring the server to store data related to a diabetic condition.

23. The method of claim 17, further comprising communicating a datum relating to a correction bolus from said meter to an insulin delivery device.

24. The method of claim 23, wherein the insulin delivery device is an insulin delivery pen.

25. The method of claim 24, further comprising providing a port on the meter, the port being configured to mechanically engage an insulin delivery pen to select an insulin dosage; and mechanically communicating a datum relating to a correction bolus from said meter to the insulin delivery pen via said port.

26. The method of claim 25, further comprising configuring the port to mechanically engage a dosage selection knob of the pen and to rotate the knob a predetermined amount.

27. The method of claim 17, further comprising providing an insulin delivery pen configured to communicate electronically with the meter, the pen comprising a micro-controller configured to make available a measured dosage of insulin for injection into a patient, and electronically communicating a datum relating to a correction bolus from said meter to the insulin delivery pen.

28. A system usable by a medical caregiver to manage a diabetic condition of a patient, said system comprising:
a server containing a database of information associated with at least a first patient;
a meter associated with said first patient, said meter being adapted to calculate a correction bolus using a correction algorithm and a plurality of patient-affected and caregiver-affected variables, said meter being in two-way communication with the server;
a terminal associated with the caregiver, the terminal being adapted to allow said caregiver to view at least a portion of said information associated with said first patient, the terminal being further adapted to allow the caregiver to modify the correction algorithm associated with the first patient.

29. The system of claim 28, wherein the server is a portion of the meter.

30. The system of claim 28, wherein the terminal is a desktop or laptop computer running a software program configured to communicate with the meter and the server.

31. The system of claim 28, wherein the terminal is a desktop or laptop computer running a software program configured to communicate with the meter or the server.

32. The system of claim 28, wherein the terminal is a hand-held personal digital assistant device running a software program configured to communicate with the meter and the server.

33. The system of claim 28, wherein the terminal is a hand-held personal digital assistant device running a software program configured to communicate with the meter or the server.

34. The system of 28, wherein the caregiver-affected variables comprise:
a correction factor;
a target glucose level; and
a frequency of analyte measurements.

35. The system of claim 28, wherein said meter is adapted to measure a concentration of an analyte associated with a diabetic condition.

36. The system of claim 35, wherein the meter comprises a user interface adapted to display information to the patient.

37. The system of claim 28, wherein the meter comprises a user interface adapted to receive input of parameters affecting glucose concentrations from the patient.

38. The system of claim 28, wherein the meter is configured to communicate with an insulin-delivery device.

39. The system of claim 38, wherein the meter comprises a port configured to mechanically engage an insulin delivery pen to select an insulin dosage.

40. The system of claim 39, wherein the port is configured to mechanically engage a dosage selection knob of the pen and to rotate the knob a predetermined amount.

41. The system of claim 40, wherein the predetermined amount is determined by the meter.

42. The system of claim 38, further comprising an insulin delivery pen configured to communicate electronically with the meter, the pen comprising a micro-controller configured to make available a measured dosage of insulin for injection into a patient.

43. The system of claim 28, wherein the server comprises databases of information associated with a plurality of patients.

44. The system of claim 28, further comprising a plurality of meters associated with said first patient.

45. The system of claim 28, further comprising a plurality of meters associated with a plurality of patients.

46. The system of claim 28, further comprising a security system configured to prevent unauthorized access to patient-specific data in the system.

47. A system for managing a diabetic condition of a patient, the system comprising:
a handheld meter comprising a digital memory and computing abilities, the digital memory being programmed with a correction algorithm for calculating a correction bolus from a plurality of parameters;
a server in two-way communication with said meter;
wherein at least some of said parameters for calculating said correction bolus are stored in and updatable by said server;
wherein the server is configured to allow a care giver to remotely modify at least one of said parameters for calculating a correction bolus.

48. The system of claim 47, wherein the server is a personal computer.

49. The system of claim 47, wherein the server is a handheld personal digital assistant.

50. The system of claim 47, wherein the server is a portion of the handheld meter.

51. The system of claim 47, wherein the meter is further adapted to measure a concentration of an analyte related to a diabetic condition in said patient.

52. The system of claim 51, wherein said concentration of said analyte is one of said parameters for calculating a correction bolus.

53. The system of claim 52, wherein one possible correction bolus is a dosage of insulin.

54. The system of claim 47, further comprising a security system configured to prevent unauthorized access to patient-specific data in the system.
